(19) United States
(12) Patent Application Publication
(10) Pub. No.: US 2012/0250658 A1
(43) Pub. Date: Oct. 4, 2012

(54) METHOD, APPARATUS AND RELATED COMPUTER PROGRAM FOR DETECTING CHANGES TO A NETWORK CONNECTION

(75) Inventors: Jochen Eisl, Garching (DE); Joerg Abendroth, Munich (DE); Jari Pekka Mustajarvi, Espoo (FI)

(73) Assignee: NOKIA SIEMENS NETWORKS OY, Espoo (FI)

(21) Appl. No.: 13/515,335

(22) PCT Filed: Dec. 15, 2009
(86) PCT No.: PCT/EP09/67170

§ 371 Date: Jun. 12, 2012

(51) Int. Cl. H04W 36/00

(52) U.S. Cl. 370/331

(57) ABSTRACT

A method, a device, and a computer program product detect changes to the connection of a device, such as a mobile device to a network, and initiate at least one measure when changes are detected. Changes might be caused by malicious users or malicious mobile phone SW in order to perform Denial of Service (DoS) attacks to the network. Those changes could be, for example, frequent handover actions, frequent attach/detach actions or frequent Packet Data Protocol context activation, deactivation or modification actions initiated by a mobile device or a group of mobile devices. The changes to the connection are detected by checking if parameters related to the mobile device, or related to network elements, violate defined policy rules. The detection itself is done in a network element, such as a core network element.

### TECHNICAL FIELD OF THE INVENTION

The present invention relates generally to wireless and fixed networks, and there to network connections between device(s) and the network. More specifically, the present invention relates to a method, an apparatus and a related computer program product for detecting changes to a network connection.

Examples of the present invention are applicable, but not limited, to Global System for Mobile communication (GSM) networks, Universal Mobile Telecommunications System (UMTS) networks, Code Division Multiple Access (CDMA) networks, Worldwide Interoperability for Microwave Access (WIMAX) networks, Wireless Local Area Networks (WLAN), Long Term Evolution (LTE) and System Architecture Evolution (SAE) networks, Cable networks and DSL networks.

### BACKGROUND OF THE INVENTION

In a telecommunication network various causes exist why a connection between a device and the network might be changed. For example when a mobile device (or fixed device with access to a wireless network) connects or disconnect to/from the wireless network (when the device is switched ON or OFF or if the GPRS connection of a mobile device is switched ON or OFF) or if for example a mobile device moves and leaves the area of the network cell where it is currently connected to (which results in a handover action of the connection and so in a change of the connection). Further the connection may be changed by activation, deactivation or changing one or more PDP context(s).

In case of wireless networks typically handover actions will be performed from one cell to another cell within the same network. However due to the increasing availability of more and more different wireless access network types also the handover from one access network type to another access network type becomes more and more probable, assuming that the mobile device supports multiple access networks.

Handover actions of a mobile device within the same wireless network, or between different wireless networks, can be triggered by several criteria, for example by detecting a change in the quality of the radio bearer based on measured radio link attributes or by observing changes to the end-to-end Quality of Service (QoS) on a radio link. If such a change is detected, and another radio bearer with sufficient quality is available, a handover action of the mobile device from one radio bearer to another radio bearer will be initiated. The handover action may be triggered automatically by the network or the device.

With the 3^{rd} Generation Partnership Project (3GPP) release 8 specification a mobile device may be connected either through a 3GPP access network or through a non 3GPP access networks to a 3GPP core network. Handover actions between 3GPP access networks and non 3GPP access network are possible and might be also initiated by the user of the mobile device.

However, user initiated handover may be triggered by mistake, by a malicious user or even by malicious mobile device software. A user staying with his mobile device in an area with simultaneous access to several access networks may initiate handover actions between the different access networks in a continuous way. Movement of the user is not necessary in this case.

Same applies to situations where network connection of a mobile device are established or torn down, or to situations where one or more Packet Data Protocol (PDP) context are activated, deactivated or changed (for example by switching GPRS ON or OFF), also those actions might be triggered by mistake, by a malicious user or by malicious software.

Handover actions, network connection establishment or teardown actions and PDP context activation, deactivation or modification actions consume network resources which in turn reduces performance of the network, especially if frequent actions occur. Therefore those actions without purpose (without any real need) should be avoided. It is noted that such frequent handover actions and frequent connections establishment/teardown actions, which may be initiated by a malicious user or software, are just example for not needed actions which consume network resources and so reduce network performance. Same applies in practice to any connection related parameter or to requested connection resources, which could be also changed without any real need.

With the introduction of user initiated handover the probability of continuous changes to a network connection of a mobile device without any real purpose, so called denial-of service (DOS) attacks, increases and becomes a threat for mobile networks. For example a single user or a group of users could trigger frequent actions leading to frequent changes of the connection between mobile device(s) and a network. DOS attacks could be also caused mobile devices infected for example by malicious software. Infected mobile devices might start malicious activities based on the geographical position of the mobile devices. When entering such an area the mobile device could try to identify other infected mobile devices in the same area and start a DOS attack for example by coordinated frequent handover, connection establishment/teardown actions or PDP context activation/deactivation or modification actions, or the mobile device could even try to infect other mobile devices located in the same area.

### SUMMARY OF THE INVENTION

In consideration of the above, it is an object of the present invention to overcome the above mentioned problem of possible changes to a connection of device(s) (preferable mobile devices) to a network caused by for example a malicious user or mobile device. In particular, the present invention provides a method, an apparatus and a related computer program product for detecting changes to a connection of mobile device(s) to a network. If changes to the connection, resulting for example from frequent actions without purpose, are detected measures may be applied in order to for example inhibit such frequent actions or inform the user or network operator about it.

According to an example of the present invention, in a first aspect, this object is for example achieved by a method for detecting changes to a connection of a mobile device to a network whereby the detecting is done by determining if at least one parameter related to the mobile device or related to the network is violating a policy rule related to the changes, and if a policy rule is violated initiating at least one measure related to the detected changes.

According to further refinements of the example of the present invention as defined under the above first aspect, the method further comprises the claimed subject matter of any of the claims 2 to 21.

According to an example of the present invention, in a second aspect, this object is for example achieved by a network element for detecting changes to a connection of a mobile device to a network, the network element comprising a determining means determining if at least one parameter related to the mobile device or related to the network is violating a policy rule and a measure means initiating at least one measure related to the detected changes if a policy rule is violated.

According to further refinements of the example of the present invention as defined under the above second aspect, the network element further comprises the claimed subject matter of any of the claims 23 to 43.

According to an example of the present invention, in a third aspect, this object is for example achieved by an apparatus for detecting changes to a connection of a mobile device to a network, the apparatus comprising a determining means determining if at least one parameter related to the mobile device or related to the network is violating a policy rule and a measure means initiating at least one measure related to the detected changes if a policy rule is violated.

According to further refinements of the example of the present invention as defined under the above third aspect, the apparatus further comprises
a generating block for generating the at least one parameter from data received from a mobile device or from at least one other network element
a measure block applying measures to the mobile device or a management system or another network element after detecting the changes to the connection of the mobile device to the network
optionally at least one processor and at least one memory including computer program code, wherein the at least one memory and the computer program code are configured to, with the at least one processor.

According to further refinements of the example of the present invention as defined under the above third aspect, the apparatus further comprises at least the claimed subject matter of any of the claims 23 to 43.

According to an example of the present invention, in a fourth aspect, this object is achieved by a computer program comprising code for detecting changes to a connection of a mobile device to a network as claimed in any one of the claims 1 to 21 when the computer program is run on a processor.

According to further refinements of the example of the present invention as defined under the above fourth aspect, wherein the computer program is a computer program product further comprises a computer-readable medium bearing computer program code embodied therein for use with a computer.

Embodiments of the present invention can provide one or more of the following advantages:
Consumption or reservation of network resources without purpose is avoided.
DoS attacks can be detected, reported and inhibited.
Decrease of network performance, and so the decrease of user experience in the network, is avoided.
Possible network outage or unavailability due to overload situations caused by malicious frequent connection changes is avoided.
Only malicious connection changes are detected and inhibited while still allowing normal connection changes.

### BRIEF DESCRIPTION OF THE DRAWINGS

Examples of the present invention are described herein below with reference to the accompanying drawings, in which:

FIG. 1 illustrates a first example embodiment of a high level network architecture where the invention is used; and

FIG. 2 presents a second example embodiment of a high level network architecture where the invention is used; and

FIG. 3 shows method steps related to the present invention; and

FIG. 4 illustrates method steps related to the present invention in more detail; and

FIG. 5 shows a third example embodiment of a network element according to the present invention; and

FIG. 6 presents a first example signaling diagram according to the present invention; and

FIG. 7 presents a second example signaling diagram according to the present invention; and

FIG. 8 presents a third example signaling diagram according to the present invention; and

FIG. 9 presents a fourth example embodiment of a network element according to the present invention.

### DETAILED DESCRIPTION OF THE PRESENT INVENTION

Examples of the present invention are described herein below with reference to the accompanying figures. The figures include mandatory, as well as optional elements, related to the present invention. Furthermore, the figures include mainly elements that are important for the present invention, or that are useful in the context of describing the present invention. Not important network elements, messages or signals (like for example elements where information is just relayed/passed through, or messages just acknowledging the receipt of another message) might have been left out of the figures and the description for simplification purposes.

In the description the terms Policy and Charging Rule Function (PCRF), Network Management System (NMS), Packet Data Network Gateway (PDN-GW), Mobile Device (MD), Mobility Anchor, base station (BTS), access point (AP), base station controller (BSC), Radio Network Controller (RNC), GPRS Support Node, Mobility Management Entity (MME), access network and core network are examples for elements, functions and networks without restricting or limiting them to functions, elements or networks of this specific type, or excluding any possible alternatives. The described embodiments are not limited to the mentioned networks, network elements, messages and signals.

The following paragraphs define certain terms and elements used throughout this application. These definitions are related to the example embodiments of the invention as described below and might not be directly applicable to other, alternative, embodiments of the invention not described within this document.

The term “connection” refers to a connection of a mobile device to a network or network element in a very broad sense. It covers for example the connection between the mobile device and the base station, as well as the connection between a mobile device and a core network element (for example a Serving GPRS Support Node—SGSN, where a mobile devices may attach to when establishing a GPRS connection). Further on the term “changes to a connection” covers changes to the connection between a mobile device and an access point (for example caused by a handover action to another base station/access point, where the other base station/access point might belong to the same or a different network), as well as for example attach or detach actions between the mobile device and a core network node and Packet Data Network context activation, deactivation and modification. Note, the above mentioned interpretations related to the terms “connection” and “changes to a connection” are just examples, changes related to any kind of connection between one or more mobile device and any other network element shall be covered by those terms as well.

An access network is the part of a network including for example access points (like for example base stations in case of a mobile network or a Digital Subscriber Line Access Multiplexer (DSLAM) in case of a fixed network) where the devices are connected to, and access network controller(s) or access network gateway(s) where the access points are connecting to. The access network controller(s) or access network gateway(s) are access network elements providing the interface towards a core network. An access network controller could be for example a Base Station Controller (BSC) or a Radio Network Controller (RNC) in case of a wireless or mobile network, an access network gateway could be for example an Access Service Network Gateway (ASN-GW) of a Wimax network. Typically the controller or access point network elements could include at least partly handover functionality. Access networks of different types could be for example GERAN, UTRAN, E-UTRA, CDMA2000 RAN, WLAN or Wimax (note this is just an example list and might not be complete).

A core network (or network core) is the central part of a telecom network that provides various services to customers who are connected by the access networks. Several access networks of similar or different types can be connected to one core network. Examples of core network functions are traffic aggregation, authentication, call control, switching & routing, charging, services and gateway functionality to connect to other networks (for example the Internet). Core network element may be involved in handover activities, especially if the handover relates to inter RAN handover actions between different access networks which might be even of different types. Examples for core network elements involved in handover activities are Serving GPRS Support Node (SGSN), Gateway GPRS Support Node (GGSN), Mobility Management Entity (MME), Serving Gateway (SGW) and Packet Data Network Gateway (PGW). For example a SGSN might be involved in attach or detach actions of mobile device when it establishes or tears down a connection to the network.

A policy rule in the context of this application is a rule which might be applied to a whole network, parts of a network, one or more network elements, one or more mobile devices or one or more mobile subscribers. Further a policy rule might be specific for a traffic type (for example circuit switched or packet switched traffic or traffic with different Quality of Service (QoS) requirements). Policy rules might be used to steer and shape traffic in a network, to detect abnormal situation or to control/authorize QoS related traffic or requests. They are typically stored centrally in one network element (for example in a Policy and Charging Rules Function (PCRF) network element) but may be also stored in a distributed manner in several network elements (for example several PCRFs serving different parts of the network). Policy rules can be stored and implemented basically in any network element in the core or access network. In addition to the policy rules those network elements (like for example the PCRF) might also include information about the measures that shall be applied if a policy rule is violated.

An attach/detach action describes situations where a mobile device connects/disconnects to/from a network. Examples for such actions are when the mobile device is switched ON or OFF or when the mobile device established a new type of connection with a network (like for example a GPRS data connection while still maintaining another connection like for example a voice connection).

A handover action means the shifting of a mobile device connection from one base station or access point to another one. Handover action may be caused for example by a mobile device moving from one cell served by one base station or access point to another cell, by actively selecting another base station or access point or by changing network conditions (for example if base station or access point breaks down or its maximum capacity is exceeded). The handover action can be for example triggered by the network, the mobile device or the user of the mobile device. A handover action may happen within the same access network, between access networks which may be of different types (so called heterogeneous access networks) or even between different core networks.

A Packet Data Protocol (PDP) context offers a packet data connection over which a mobile device and a network can exchange IP packets. To a PDP context belongs a data structure (or data record) including subscriber session related information for an active session (for example subscribers IP address, Tunnel end point identifier, subscriber identifier, . . . ). Several PDP contexts can co-exist. The PDP context(s) is an important part of the connection. A PDP context can be activated (newly generated), modified (for example to change connection parameter like reserved connection resources) or deactivated.

A mobile device (MD) connects to the base station or access point of a network and may be a mobile phone, a Personal Digital Assistant (PDA), a portable computer, a pager, a stationary device capable to access a wireless network or any kind of other device connecting via a radio interface to a wireless network. A stationary device could be for example a stationary computer connecting via a WLAN or HSPA dongle to a wireless network or a metering device connected to a wireless network and reporting for example events detected via sensors or acting on remotely received commands. One mobile device may have the ability to connect to several access points/networks in parallel at the same time.

A network element (for example the network element implementing the claimed invention) could be any network element located in the access or the core network. Synonyms used in the application and the claims for the term “network element” are the terms device, network device or apparatus. With respect to the present application a mobile device is not a network element.

A network management system (NMS) is a combination of hardware and software used to monitor and manage a network. Individual network elements within a network could be managed by a NMS.

A Policy and Charging Rule Function may be included in one or more core network element(s) housing policy and charging rules for a network (for example a PCRF).

Denial of Service (DoS) attacks or a distributed DOS attacks (DDoS) are attempts to make a computer resource unavailable to its intended users. One common method of attack involves saturating the target (victim) machine, node or network with external communications requests, such that it cannot respond to legitimate traffic, or responds so slowly as to be rendered effectively unavailable. In general terms, DoS attacks are implemented by either forcing the targeted node(s) to reset, or consuming its resources that it can no longer provide its intended service, or obstructing the communication media between the intended users and the targeted node so that the users can no longer communicate adequately with the target node or the network. DoS attacks might cause for example frequent handover actions, frequent attach or detach actions or frequent PDP context activation, modification or deactivation actions initiated by one or more mobile devices thus loading the involved access and/or core network nodes and so degrading the experienced network performance or availability of the normal network users. Loading of the network might happen for example on the user plane by reserving resources without using them, or on the control plane by generating extra traffic related to not needed actions caused by the DOS attack.

Frequent handover, frequent attach or detach or frequent PDP context activation, modification or deactivation actions mean in the context of this application abnormal frequent actions caused by for example a malicious user or malicious software performing a DOS attack to the network. Such actions will cause “frequent” changes to a connection between a mobile device and a network. An expert in the art is able to define criteria (for example thresholds for mobile device or network related parameters) in order to distinguish normal changes of a connection between a mobile device and a network from abnormal (frequent) changes caused by for example DOS attacks. Those criteria (thresholds) can then be used for defining policy rules to detect frequent changes to a connection caused by those frequent (abnormal) actions. For example a criteria could be the number of connection changes that happened during a specific time window. Within the description of this patent application the term “frequent changes to a connection” refers to changes caused by abnormal behavior (like for example by DOS attacks).

In general all shown figures relate to example embodiments of the present invention where one or more devices, preferably mobile devices (MDs) are causing changes to a connection between the mobile device(s) and one or more networks. Those changes are detected by a network element based on the data provided and/or collected from other network elements and/or the mobile device(s). If the detected changes of the connection violate one or more defined policy rules related to the connection (for example to detect DOS attacks), measures may be initiated or taken to stop the “frequent” connection changes, to inform the users of the mobile device(s) or to inform the network operator (for example via the network management system) about the detected “frequent” changes to the connection.

The main advantages of the above outlined invention are that the consumption or reservation of network resources without purpose is avoided, decreasing of network performance (and so the decrease of user experience) in the network is avoided, possible network outages or unavailability due to overload situations caused by malicious frequent changes to mobile device connections to the network are avoided, DoS attacks are detected and alarmed and only malicious frequent changes to mobile device connections are detected and inhibited, while still allowing normal actions like normal handover, attach/detach pr PDP context activation/modification/deactivation actions.

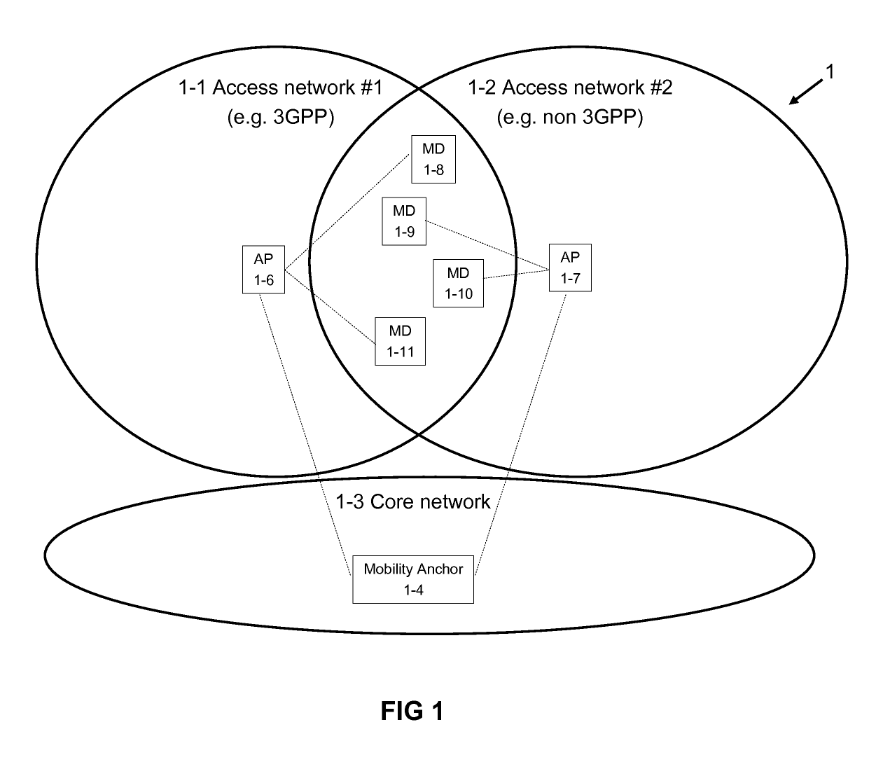

FIG. 1 shows a high level example network 1 where mobile devices 1-8 to 1-11 are connected via access networks 1-1 and 1-2 to a core network 1-3, and there to a core network element 1-4 (for example a mobility anchor). The shown connections between the network elements refer to user data connections.

The access networks 1-1 and 1-2 may be heterogeneous access network (like shown in FIG. 1) or may be access networks from the same type (not shown). Mobile devices 1-8 to 1-11 are connected to access points (AP) 1-6 or 1-7 of one of the 2 access networks 1-1 or 1-2. Access point 1-6 or 1-7 could be for example a base station, a WLAN hot spot or a DSLAM (in case that one of the access networks is a fixed network and that the mobile device is a stationary device connected on the one hand to the fixed access network and on the other hand capable to connect to a wireless access network).

Mobile devices 1-8 to 1-11 might be in the range of both access points 1-6 and 1-7 as shown in FIG. 1. Therefore those mobile devices can establish connections with both access networks (assuming that the mobile devices support both access network types and possess valid credentials for accessing the networks).

When a mobile device is switched on it either selects manually or automatically one the available access networks and attach to it. If it is switched off it detaches automatically.

If an ongoing connection of a mobile device shall be shifted from one access network to another access network a so called handover action is initiated. A handover action might be initiated for various reasons like for example by movement of the mobile device, by the user of a mobile device, by resource optimization actions or any other actions to optimize load distribution in the network. As one example the need for a handover action may be detected if the radio signal received from the access point where the mobile device is currently connected to degrades.

The handover action may be performed and/or controlled by the mobility anchor node 1-4 in the core network, by access network elements or by the mobile device itself. If for example the mobile device just changes from one access point (AP) to another one in the same access network, the handover might be performed and/or controlled by a controller or gateway located in the access network (not shown). In another situation the mobile device may decide on a handover action based on mobility policies received from core network, for example from Access Network Discovery and Selection Function (ANDSF).

Further on when a mobile device starts for example a GPRS connection, a PDP context will be activated (generated) including parameters related to the GPRS connection between the mobile device and for example a core network element like a GGSN. Those parameters related to the GPRS connection may be for example the subscribers IP address, subscriber identifier like International Mobile Subscriber Identity (IMSI) or Tunnel Endpoint Identifier(s) (TEIDs).

Compared to those reasonable and needed attach/detach, handover or PDP context activation/deactivation/modification actions as described above, unnecessary changes to a connection of a mobile device might be initiated, for example by a malicious mobile device software or any other means which can be used for initiating frequent—not needed—changes to the connection (for example frequent attach, detach, handover actions or actions related to activation, modification or deactivation of a PDP context). Reasons for such unnecessary changes to the connection might be for example DoS attacks towards the network(s) where the mobile device is connected to. DoS attack(s) might be for example coordinated between different mobile devices connected to the same network(s) which might be located in the same area or connected to the same cell. DoS attacks might be started at certain time points or time windows and are usually performed with the goal to disturb normal network operation, degrade network performance or even interrupt network operation.

One network element (for example the mobility anchor 1-4 shown in FIG. 1) collects information about changes to the connection of one or more mobile device. The information might be collected from data received or requested for example from the mobile devices, or from data received or requested from other network elements which are aware about changes to the connection of a mobile device to a network (for example aware of attach/detach, handover or PDP context activation/modification/deactivation related actions). This network element might be either located in one of the access networks or in the core network. Alternatively the collection functionality might be distributed to two or more network elements, however a central network element for the collection of this kind of information is the preferred solution.

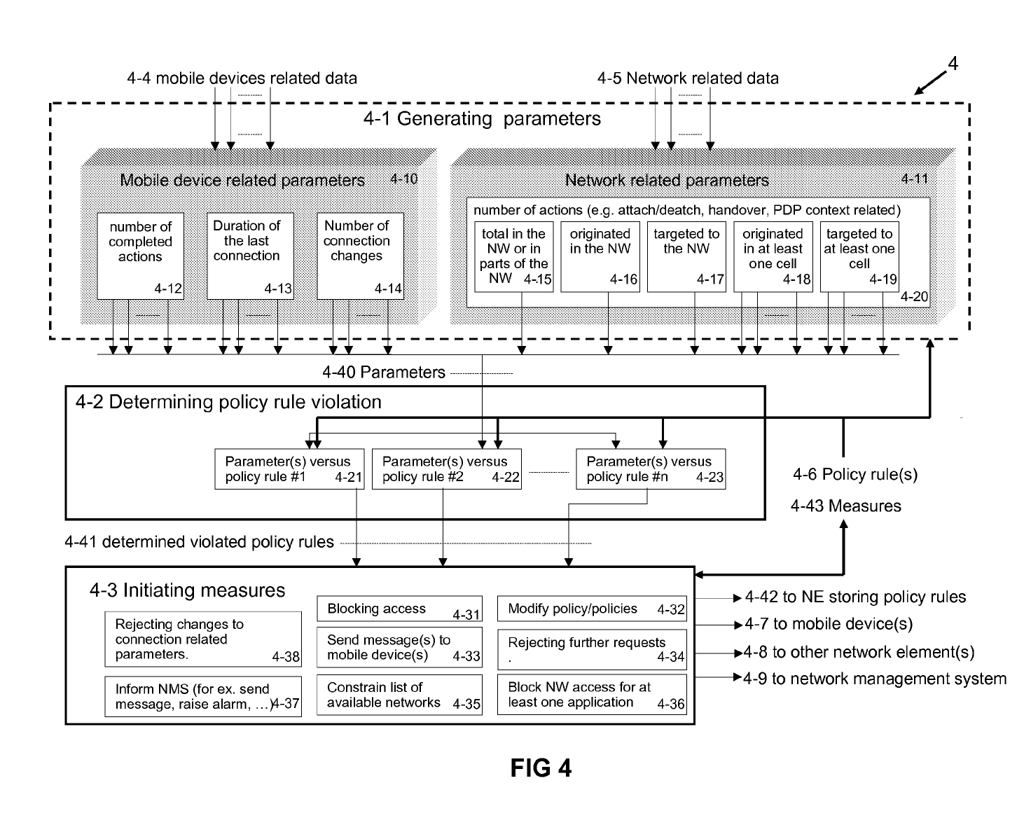

Further on the one or more network element might have also access to policy rules data. These policy rules could include rules related to frequent changes of the connection of one or more mobile devices (for example rules related to frequent attach/detach, handover or PDP context activation/modification/deactivation actions) which are then used to check from the collected data if frequent changes to the connection of one or more mobile devices are detected. As an alternative the policy rules might be also configured or pre-programmed directly in the network element performing the detection (for example the mobility anchor 1-4). Possible detailed policy rules (criteria) for detecting frequent changes to the connection of at least one mobile device to a network, and parameters used for the detection, are described later with respect to the detailed description of FIG. 4. In addition information about measures to be performed if policy rules are violated might be provided together with the policy rule data.

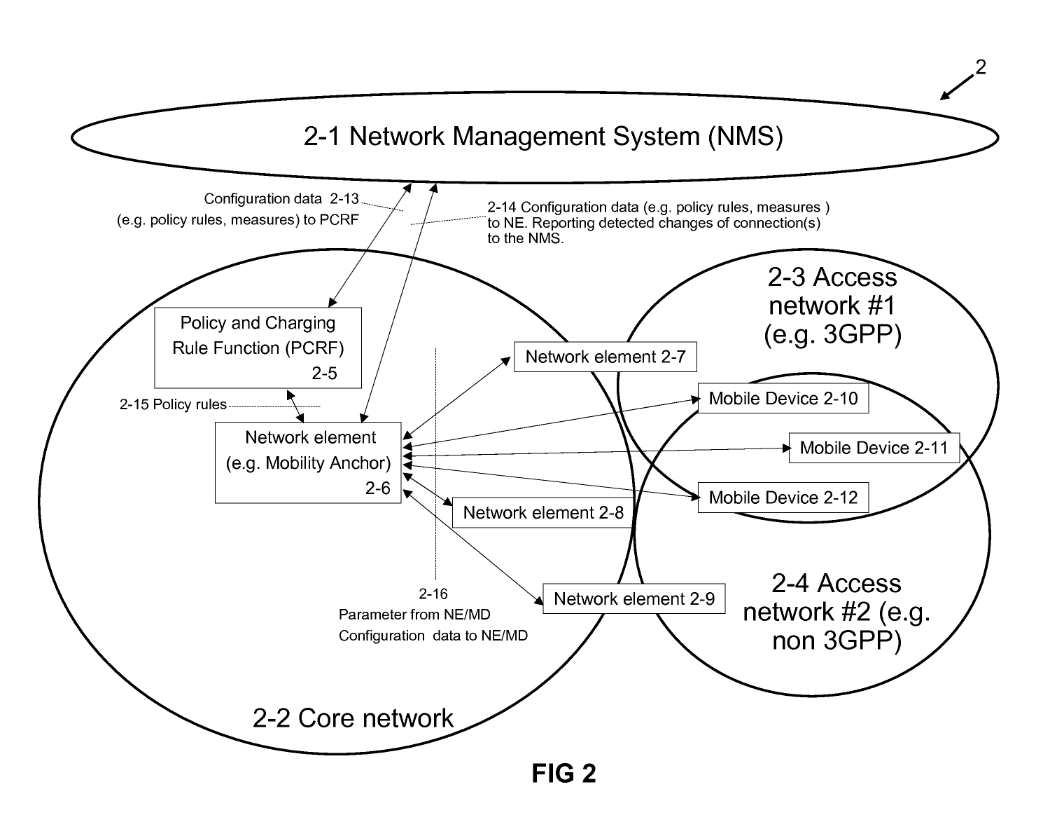

FIG. 2 illustrates another example network 2, showing network elements and logical connections between them concentrating on the transfer of information related to the detection of changes to the connection of one or more mobile device (like for example attach/detach, handover or PDP context related information) connected to the network.

The core network 2-2 and the access networks 2-3 and 2-4 are comparable to the ones shown in FIG. 1. Same applies to the mobile devices 2-10 to 2-12 and the network element 2-6 acting as mobility anchor. In addition FIG. 2 shows a Policy and Charging Rules Function (PCRF) 2-5, which may provide policy rules 2-15, for detecting changes to network connections (for example caused by frequent abnormal actions), to one or more network elements detecting those changes (for example the mobility anchor 2-6). The policy rules might be either retrieved by the network element 2-6 from the PCRF 2-5 or they might be pushed by the PCRF to the network element. In addition to the policy rules also information about measures, to be performed if a policy rule is violated, might be provided by the PCRF. Instead of the PCRF providing the policy rules (and optionally the measures) they might be also located/stored in another network element or in the network element 2-6 itself.

Further on a Network Management System (NMS) 2-1 is shown in FIG. 2. The NMS provides for example configuration data 2-13 and 2-14 to the PCRF or the network element 2-6. This configuration data might be related to policy rules, for example policy rules for detecting frequent (abnormal) changes to the connection of at least one mobile device and optionally also to the measures that should be performed when a policy is violated. Further on the NMS 2-1 might receive 2-14 data and information from the network elements (for example the mobility anchor 2-6) or other network elements reporting information related to detected frequent changes to a connection directly (not shown) to the NMS 2-1. The mobility anchor 2-6 (or any other comparable network element collecting information related to the frequent changes of a connection) may receive policy rules for detecting frequent changes of a connection for example from the PCRF 2-5 or from the NMS 2-1.

Still further on FIG. 2 shows also other network elements 2-7 to 2-9, which could be either located in one of the access networks 2-3 or 2-4 (for example a base station or access point), in the core network 2-2 (for example a SGSN) or at the border between one of the access networks and the core networks as a binding network element between them. Those binding network elements could be for example a gateway network element or an access network controller (like a base station controller (BSC) or a radio network controller (RNC)).

Network elements 2-7 to 2-9 and the mobile devices 2-10 to 2-11 might receive configuration data from network element 2-6 (for example the mobility anchor 2-6 as shown in FIG. 2) or from the NMS directly (not shown). This configuration data might include potential measures applied to those network element and/or the mobile devices after detecting frequent changes to a network connection. Further on the network elements 2-7 to 2-9 and the mobile devices 2-10 to 2-12 might report information related to the connection of mobile devices (for example related to changes of the network connection) to the network element 2-6, to the NMS 2-1 directly (not shown) or to any other network element involved in the detection of frequent changes to the connection of at least one mobile device to the network.

The procedure for detecting frequent changes to the connection is the same as explained in the description related to FIG. 1, therefore it is not repeated here.

The network element 2-6 (for example a mobility anchor) may receive or pull information related to changes of the connection of the mobile devices from other network elements or the mobile devices. Based on this information the network element 2-6 checks if defined policy rules are violated in order to detect frequent changes of the connection. If frequent changes are detected this might be reported to the NMS 2-1 (for example in form of an alarm or performance data information which will be fetched from the NMS 2-1). Further on measures might be applied to the mobile devices or the network elements in order to stop not needed frequent changes to the connection or to inform the user(s) of the mobile device(s) about it.

The PCRF 2-5 is just a preferred network element for providing policy rules (and optionally measures) related to the detection of the frequent changes. Basically those policy rules and measures might be also stored and provided by any other network element, or could be configured directly to the network element detecting the frequent changes (for example the mobility anchor 2-6).

The mobility anchor 1-3/2-6 shown in FIG. 1 and FIG. 2 is just a preferred network element for detecting frequent changes of the connection of at least one mobile device to the network. In principle the detection can be also done by any other network element or a group of network elements. If the detection is not done in the mobility anchor, the mobility anchor might need to transfer information/data related to changes of the connection to other network element(s) implementing the detection function.

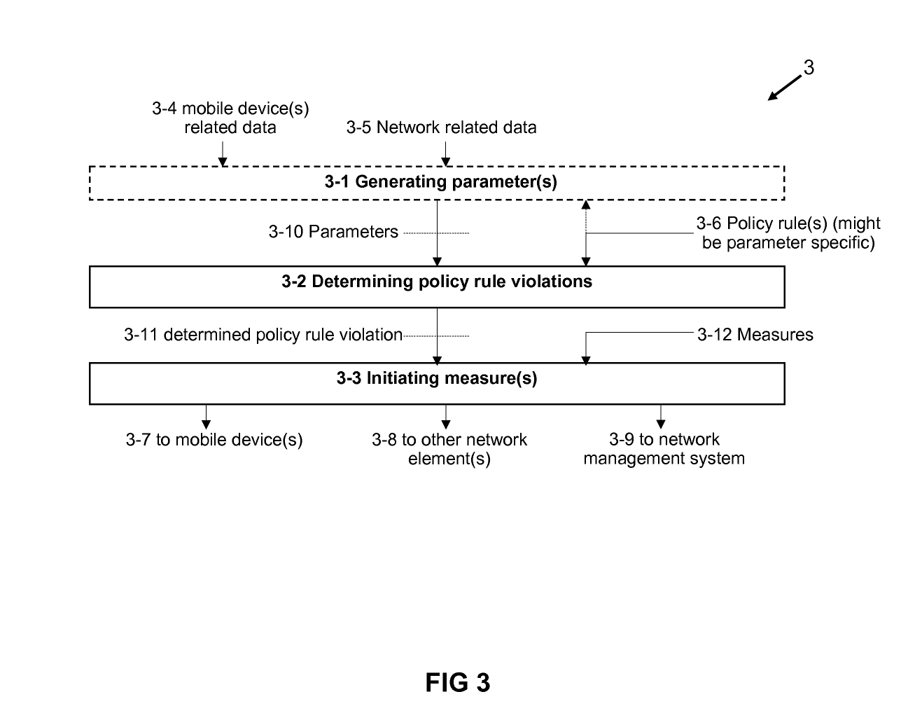

FIG. 3 and FIG. 4 illustrate flow diagrams of a method related to the present invention. Flow diagram boxes with dotted lines show optional elements while boxes with solid lines show mandatory elements. Elements included in a box with dotted lines are automatically optional, independent if they are shown with dotted or solid lines.

Turning to FIG. 3 which illustrates a high level flow diagram 3 of a method related to the present invention.

In a first step 3-1 one or more parameters are generated which are later on used to determine policy rule violations and as a consequence detecting frequent changes to a connection of at least one mobile device. The data needed to generate those parameters is either automatically received (for example periodically) or requested from mobile device(s) 3-4 or from other network elements 3-5. The generated parameters might depend on the applied policy rules (3-6).

The generated parameters may be specific parameters for a dedicated mobile device, for a group of mobile devices, for the whole network or for a part of the network (for example one or more cells of the network). Further on the parameters may include a time dimension, which means that the parameters are generated for data or events falling into a specific time window. The generated parameters are then transferred 3-10 to the second step 3-2. More details related to the generated parameters are described in connection with FIG. 4.

In a second step 3-2 the generated parameters will be evaluated together with one or more policy rule 3-6 to determine if a policy rule is violated and as a result detecting frequent changes to the connection of at least one mobile device connected to a network. Those policy rules might be either received from external (as shown in FIG. 3 by 3-6) or might be preconfigured. A time dimension (which might be part of the policy rule) may be taken into account when doing the evaluation (note, this is optional for step 3-2). If a violation of a policy rule is determined frequent changes to the connection are recognized and information about the violated policy rule is forwarded 3-11 to the third step 3-3. The forwarded information may include information about the violated policy rules, the one or more mobile devices which are violating the policy rule and the network or network portion where the violation was detected. More details about the policy rules are described in connection with FIG. 4.

In a third step 3-3 information about the violated policy rule(s) is received 3-11 and measures are selected and initiated to the at least one mobile device 3-7, to other network elements 3-8 or to the NMS 3-9. Information about the measures may be received from external 3-12, for example from a PCRF or a NMS which might provide them together with the policy rules. Alternatively the measures may be pre-programmed. The other network elements may be network elements located in the core or access network(s) where the one or more mobile device is currently connected to, handed over to, tried to be handed over to or involved with for any of the previously mentioned actions. These network elements could be for example base stations, access points, base station controllers (RNC/BSC) or gateways. If the network element which has determined the violation of a policy rule is involved in the handover, attach/detach or PDP context activation/modification/deactivation action itself, measures might be also initiated or applied directly to the network element including the determining function. Initiated or applied measures could be for example blocking network access for an indefinite or limited time or informing the NMS or the user(s) of the mobile device(s) about the frequent actions. More details about possible measures are described in connection with FIG. 4.

FIG. 4 shows a more detailed view on the steps of the flow diagram illustrated and described in connection with FIG. 3.

Details of the optional generation of parameters are shown in step 4-1. Received mobile device related data 4-4 may be for example indications of a performed or planned handover, attach/detach action or PDP context activation/modification/deactivation actions, optionally with timing information (like when has the action happened or when is it planned to happen). Further on information about the involved networks or network parts (for example cells) and the reasons for the action (for example initiated by the user, initiated by the device due to degrading radio signal or initiated by the by the network . . . ) may be included.

The mobile device related data is processed in the “mobile device related parameters” sub-step 4-10, and parameters like for example the number of completed actions 4-12 (for example handover actions, attach/detach actions, PDP context activation/modification/deactivation actions), the duration of the last connection of a mobile device to a network 4-13 and the number of connection changes 4-14 of a mobile device to a network are generated. The mentioned parameters are just examples for parameters that can be used to detect frequent changes to the connection of at least one mobile device, therefore the mentioned list of mobile device parameters is not exclusive. Other possible parameters could be for example the amount of data transferred during a connection.

Mobile device related parameters 4-10 might be generated for a single mobile device or a group of mobile device. Further on the parameters might be generated for a defined time window, which means that only events falling into the sliding time window are counted. Different time windows might be defined for different parameters.

Received network related data 4-5 may include information related to handover actions, attach/detach actions or PDP context activation/modification/deactivation actions. Further on the data may include information about the involved one or more mobile devices, the network area or cell(s) where the actions occurred, the target and the originating networks involved in the actions (for example in case of handover actions) and other related data (for example the amount of transferred data during a connection). Further on information about the reason(s) for initiating the actions and timing information might be included. The network related data is processed in the “network related parameters” sub-step 4-11. Generated network related parameters may be the number of completed actions 4-20 for the total network or parts of the network 4-15, number of actions originated in the network or in parts of the network 4-16, number of actions targeted to the network or at least to parts of the network 4-17, number of actions originated in one cell of the network 4-18 or number of actions targeted to one cell of the network 4-19. The mentioned parameters are just examples of parameters that may be used, therefore the mentioned list of network related parameters is not exclusive.

Network related parameters 4-11 might be generated for a defined time window, which means that only events falling into the sliding time window are counted. Different time windows might be defined for different parameters.

In general a selection of all the parameters to be generated in step 4-1 (mobile 4-10 and device related parameters 4-11) might depend from the policy rules 4-6 to be used for detecting frequent changes to the connection of at least one mobile device to a network.

The one or more time windows mentioned for the generation of the mobile device or network related parameters might be pre-configured, could be configured on the fly (for example via a network management system—not shown) or could be extracted from the policy rules 4-6. Further on defined time windows might be modified if frequent actions were detected (for details refer to the description related to initiating measures step 4-3 of FIG. 4 below).

The generated one or more parameters are forwarded 4-40 from the generating parameter step 4-1 to the determining policy rule violation step 4-2.

In the determining policy rule violation step 4-2 the received parameters 4-40 are processed together with policy rules in order to detect policy rule violations indicating frequent changes to a connection. Policy rules might be either pre-programmed or received from external (for example from PCRF or a NMS as shown in FIG. 2). Different policy rules might apply for different areas or groups (for example for detecting frequent changes of a connection of a single mobile device or of a group of mobile devices, or for detecting frequent changes of one or more connections in a network or in parts of a network . . . ) or might be related to a combination of those. Within one area or group one or more criteria (for example number of completed handover actions, number of attach/detach actions, number of PDP context activations/modifications/deactivations, duration of a connection, number of handover actions originated in a cell might be used within one policy rule.

A policy rule might include one or more thresholds for one or more parameter. A device may be assumed to violate a policy if one or more of those thresholds are crossed. A timing window (comparable to the one used in step 4-1) can be applied also for a policy rule. A policy rule might include AND, OR, less than, more than, equal and other operations for different parameters and related thresholds. The thresholds itself might be part of the policy rules.

Example of a policy rule:

### Parameters:

A=number of completed handover actions of mobile one device

B=Duration of last network connection of the mobile device

Policy rule:

IF ((within TW (A>5)) and (B<10 s)) THEN policy_rule=VIOLATED

TW=time window=e.g. 1 minute

In the above example “5” is the threshold for the number of the completed handover actions and “10 s” is the connection time threshold.

Determining frequent changes to the connection might happen utilizing several policy rules, which might be related to different parameters or different combination of parameters, in parallel as shown in step 4-2 (see 4-21, 4-22 and 4-23).

The result of the different policy rule checks 4-21 to 4-23 may be transferred separately to the initiating measures step 4-3, or may be combined to a single indication (not shown in FIG. 4) by logical AND/OR operations of the one or more policy rules. In addition information about which policy rule is violated, which threshold are when crossed and how much it is exceeded might be transferred in 4-41 together with the result(s) from the policy rule check to step 4-3.

The initiating measures step 4-3 checks the result from the determining policy rule violation step 4-2 and may initiate or apply at least one measure accordingly. The at least one measure might dependent from the violated policy rule (and related parameters and information received from 4-2 as described in the previous paragraph) and might be either pre-programmed or received from external 4-43, for example together with the related policy rules 4-6 possibly from a PCRF. Alternatively the measure(s) might be requested on demand 4-43 from an external network element. The measure(s) might be applied to a network element involved in the action(s) causing the frequent changes to a connection 4-8 (for example to a base station or base station controller for blocking mobile device access to the network 4-31), a network element storing the policy rules 4-42 (for example the PCRF in FIG. 2 or the network element performing the determining step 4-2 if the policy rules are stored there), a network management system (NMS) 4-9 or to at least one mobile device 4-7 (for example sending a message to the mobile device(s)). If coordinated frequent actions of a group of mobile devices are detected then also the measure(s) may be initiated or applied for/to the whole group of mobile devices.

Possible measures may be rejecting changes to connection related parameters 4-38 (for example modifying a PDP context), informing the network management system (NMS) 4-37 (for example by raising an alarm or providing status information which can be read be the NMS), blocking network access for the mobile device 4-31, modifying policies 4-32 (these could be policies related to the policy rules for detecting frequent changes to a network connection of a device or network access policies stored in the mobile device), sending messages to the mobile device(s) 4-33 informing the user(s) about the detected frequent changes to the connection, rejecting further handover request from the mobile device(s) 4-34, constraining the list of available networks for handover 4-35 and blocking network access for at least one application 4-36.

A time window for applying the measure(s) might be defined, thus for example the blocking of network access for one or more mobile devices might be limited to a certain time. The time window might be common for several measures or could be specific for only one measure.

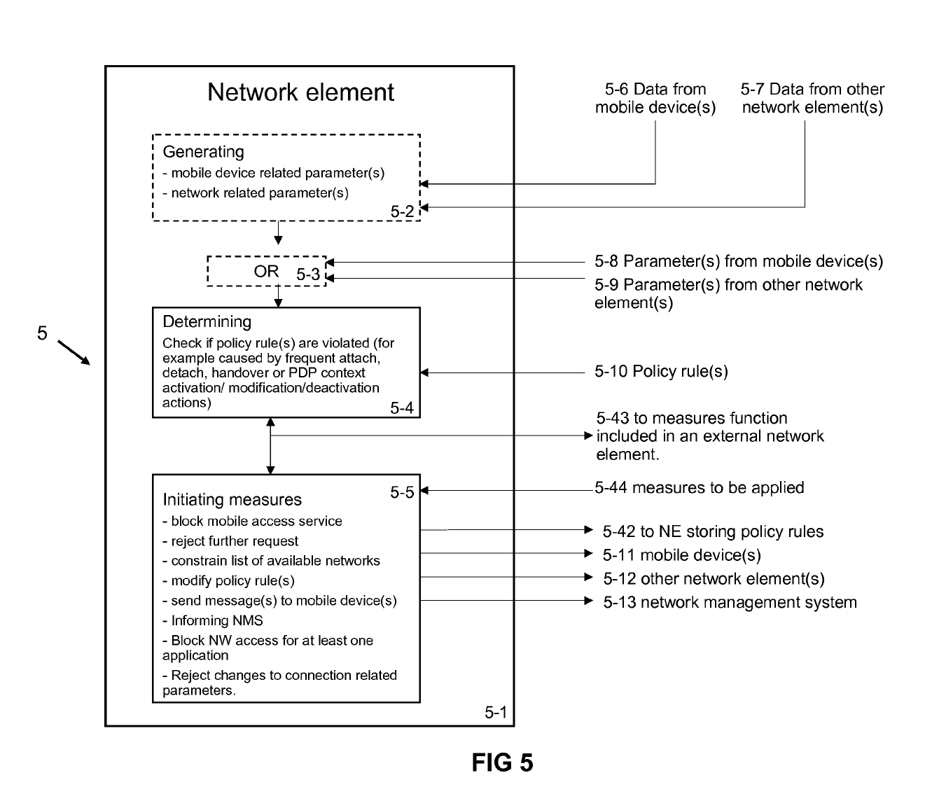

FIG. 5 shows a network element 5-1 implementing the present invention of detecting frequent changes to a connection of at least one mobile device to a network. The network element 5-1 might be either a dedicated network element for the shown functionality or it might be integrated into another network element (for example to a PCRF or a Packet Data Network Gateway).

The network element 5-1 may receive data from the at least one mobile device 5-6 or from other network elements 5-7 involved in or observing actions related to changes of the connection of at last one mobile devices to a network (for example handover, attach/detach actions or PDP context activation/modification/deactivation) and generates in a generating block the needed parameters as described in detail with respect to FIG. 4 step 4-1. Alternatively those parameters might be generated external from the network element 5-1 and might be provided to the network element either on request, on a periodic basis or in real time (refer to 5-8 and 5-9). A logical OR selection 5-3 shown in FIG. 5 underlines the options, however the OR function might not be part of the network element 5-1.

Independently if the parameters are generated by the network element 5-1 internally or received from external, those parameters are fed into a determining block 5-4 which might also receives policy rules 5-10 and performs a policy rule check taking those parameters into account. Alternatively to receiving the policy rules from external the policy rules might also pre-configured (not shown) in the network element 5-1, for example pre-configured by a network management system (refer to FIG. 2 and the related sections of the description). The determination if one or more policy rules are violated happens as described for FIG. 4 step 4-2. The result is forwarded to the initiating measures block 5-5.

The initiating measures block 5-5 initiates or applies measures according to the determination results provided by block 5-4. Those measures could initiated or applied for example to the network element storing the policy rules 5-42 (for example a PCRF), to at least one mobile device 5-11, to other network element 5-12 or to a network management system (NMS) 5-13. The measures might be either pre-programmed or received from external 5-44 (for example from a PCRF or a NMS). The measures might be provided together with the policy rules to the network element, however they might be also requested by the network element on demand from the external network element. The initiated or applied measures as described with respect to FIG. 4 step 4-3 apply also to the initiating measures block 5-5 and are therefore not described here in detail again. The initiating measures block 5-5 might be included in the element 5-1 as shown in FIG. 5, or it might be part of an external network element (not shown). If the initiating measures block 5-5 is not part of network element 5-1 the results from the determining block 5-4 will be output 5-43 from network element 5-1 and transmitted towards a network element including the initiating measures block functionality.

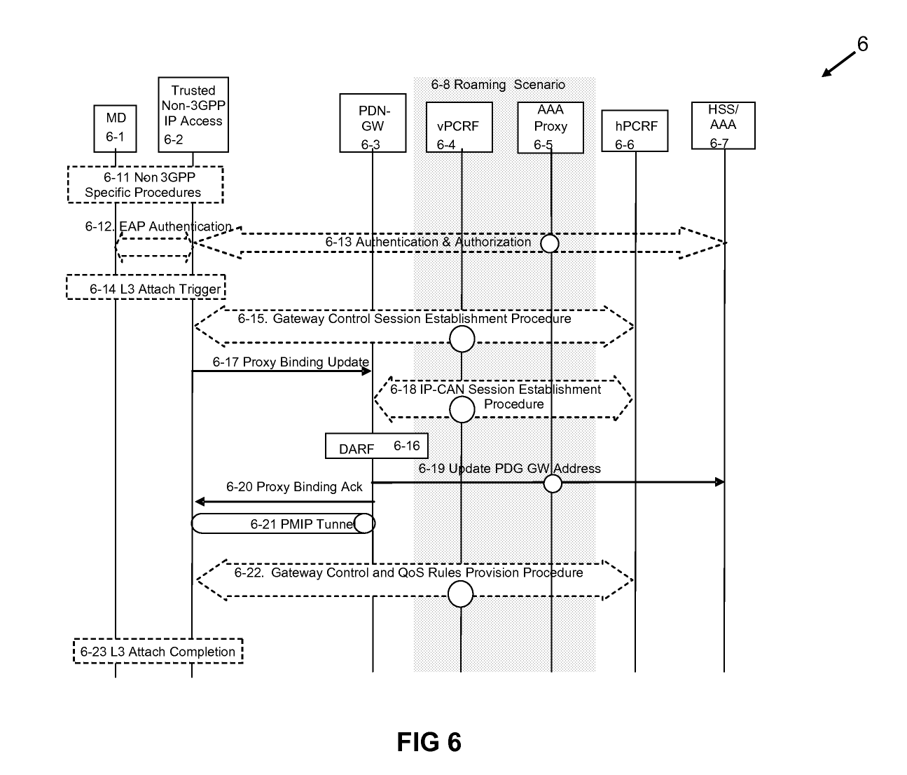

FIG. 6 shows a signaling diagram related to an example embodiments of the present invention. The signaling diagram 6 describes a standard 3GPP attach procedure of a mobile device 6-1 via a non-3GPP IP access network 6-2 to a network. The standard attach procedure is extended by one element 6-16 related to the present invention and certain additions are proposed to already existing steps and network element as described below.

Further shown network elements are the following 3GPP core network elements:
a Packet Data Network Gateway 6-3 (PDN-GW)
a visited network Policy and Charging Rule Function 6-4 (vPCRF)
a visited network Authentication, Authorization and Accounting proxy server 6-5 (AAA Proxy)
a home network PCRF 6-6 (hPCRF)
a home network Home Subscriber Server (HSS)/AAA server 6-7).

A DoS Attack Recognition Function (DARF) 6-16 is introduced which includes functionality related to parts of the present invention for detecting frequent changes to a connection of one or more mobile devices to a network. The DARF function might be a stand alone element or might be integrated into another network element as for example shown into the PDN-GW 6-3.

Only the steps important for the invention will be described in connection with FIG. 6, parts of the signaling diagram that reflects standard (known) functionality will be only roughly or not at all described.

First the mobile device 6-1 performs together with the trusted non-3GPP IP access network 6-2 initial layer 2 procedures 6-11 to initiate the setup of a connection. In next steps 6-12 and 6-13 the mobile device is authenticated. If a frequent change to the connection of the mobile device has been recognized earlier (for example a DoS attack which caused frequent attach/detach actions) the HSS/AAA server may be aware about it (the HSS/AAA server might have been informed about it via measure 4-8 of FIG. 4). The HSS/AAA server may then reject the request at this stage (not shown) or inform the mobile device about it (not shown).

If the authentication and authorization was successful the mobile device triggers a layer 3 attach action 6-14. The proxy binding update message 6-17 may be then used as an indication for the Packet Data Network Gateway 6-3 (PDN-GW) to perform a check in order to detect frequent changes to the connection of the mobile device. The PDN-GW might obtain related information (for example policy rules and related measures) from the PCRF in step 6-18. Via the DoS Attack Recognition Function (DARF) 6-16, which implements the detection functionality for detecting frequent changes to a connection, the PDN-GW performs a corresponding check. If frequent changes to the connection are detected the PDN-GW 6-3 might report this in step 6-19 to the HSS/AAA server 6-7 (for example by applying a measure to the HSS/AAA server 6-7 to reject future attach requests from this mobile device). In step 6-20 the PDN-GW may then reject the current connection request of the mobile device 6-1.

If no frequent changes to the connection of the mobile device are detected in step 6-16 the attach procedure is continued in steps 6-21 and 6-22 and finalized in step 6-23.

It should be noted, that a similar diagram could be drawn also for the detach case. If multiple mobile devices perform a coordinated attach this may be detected by the DARF function 6-16 by correlating the result from the checks performed for several mobile devices.

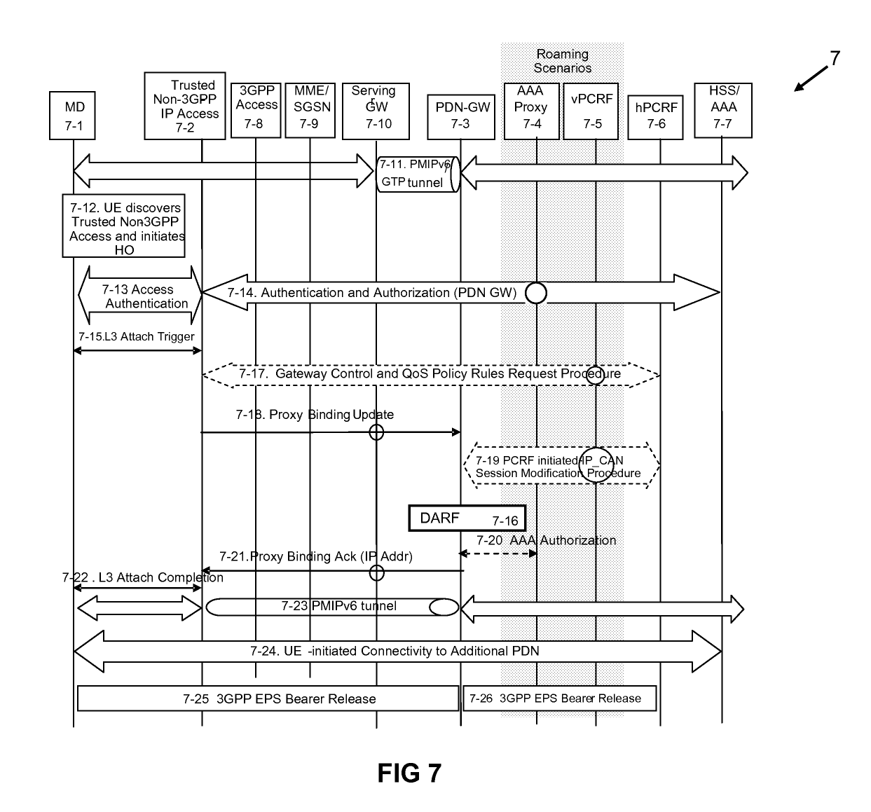

Turning now to FIG. 7 showing another signaling diagram related to another example embodiment of the present invention. The signaling diagram 7 describes a standard 3GPP handover procedure of a mobile device 7-1 from a 3GPP access 7-8 to a trusted non-3GPP IP access network 7-2. The standard handover procedure is extended by one element 7-16 related to the present invention, and certain additions are proposed to already existing steps and network element as described below.

Further shown network elements are the following 3GPP core network elements:
a Packet Data Network Gateway 7-3 (PDN-GW)
a visited network Policy and Charging Rule Function 7-4 (vPCRF)
a visited network Authentication, Authorization and Accounting proxy server 7-5 (AAA Proxy)
a home network PCRF 7-6 (hPCRF)
a home network Home Subscriber Server (HSS)/AAA server 7-7).
a 3GPP access network 7-8
a Mobility Management Entity (MME)/Serving GPRS Support Node (SGSN) 7-9
Serving Gateway 7-10

A DoS Attack Recognition Function (DARF) 7-16 is introduced which includes functionality related to parts of the present invention for detecting frequent changes to a connection of one or more mobile devices. The DARF functionality might be a stand alone element or might be integrated into another network element as for example shown into the PDN-GW 7-3.

Like in FIG. 6 only the steps important for the invention are described in connection with FIG. 7, parts of the signaling diagram that reflects standard (known) functionality will be only roughly or not at all described.

Instead of FIG. 6 the mobile device 7-1 has already established a connection 7-11 via the trusted 3GPP access network 7-8, the serving GW 7-10 and the PDN-GW 7-3. Now the mobile device 7-1 discovers a trusted non 3GPP access network 7-2 and initiates a handover action 7-12.

In next steps 7-13 and 7-14 the mobile device is authenticated via the trusted non 3GPP access network 7-2. Like in FIG. 6 HSS/AAA server may reject the request at this stage (not shown) if a frequent change to the connection of the mobile device has been recognized earlier (for example caused by earlier frequent handover actions).

If the authentication and authorization was successful the mobile device triggers a layer 3 attach action 7-15. The proxy binding update message 7-18 may be used as an indication for the Packet Data Network Gateway 7-3 (PDN-GW) to perform a check in order to detect frequent changes to the connection of the mobile device 7-1. The PDN-GW might obtain related information (for example policy rules and related measures) from the PCRF in step 7-19. Via the DoS Attack Recognition Function (DARF) 7-16 the PDN-GW performs a check in order to detect frequent changes of the connection of the mobile device 7-1. If frequent changes to the connection are detected (for example frequent handover actions) the PDN-GW 7-3 might report this to the HSS/AAA server (not shown). As a result the PDN-GW may then reject the current connection (handover) request of the mobile device in step 7-21.

If no frequent changes to the connection of the mobile device are detected in step 7-16 the handover procedure is continued via steps 7-20 to 7-26 until it has been successfully completed.

If multiple mobile devices perform a coordinated DOS attack this could be detected by the DARF function 7-16 by correlating the result from the checks performed for several mobile devices.

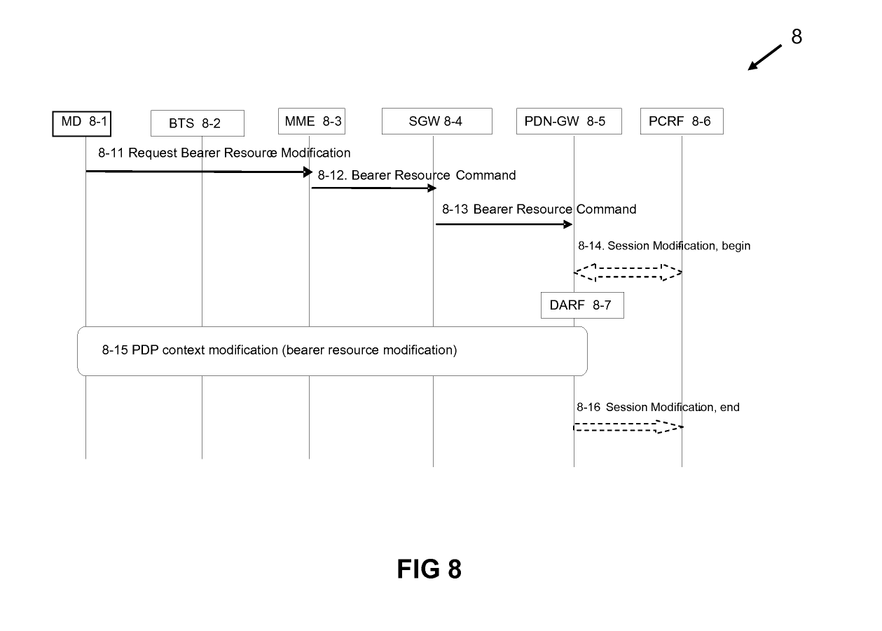

FIG. 8 shows a third signaling diagram related to another example embodiment of the present invention. The signaling diagram 8 describes a standard 3GPP PDP context modification procedure initiated by the mobile device 8-1 or the user of the mobile device (not shown). The standard PDP context modification procedure is extended by one element 8-7 related to the present invention.

Following network elements are shown in FIG. 8:
Mobile device (MD) 8-1
Base Transceiver Station 8-2
Mobility Management Entity (MME) 8-3
Serving Gateway (SGW) 8-4
Packet Data Network Gateway (PDN-GW) 8-5
Policy and Charging Rule Function (PCRF) 8-6

A DoS Attack Recognition Function (DARF) 8-7 is introduced which includes functionality related to parts of the present invention for detecting frequent changes to a connection of one or more mobile devices connected to a network. The DARF functionality might be implemented in a stand alone network element or might be integrated into another network element as for example shown integrated to the PDN-GW 8-5.

The mobile device 8-1 initiates the modification of an existing PDP context by issuing for example a request for a bearer resource modification 8-11 to the Mobility Management Entity (MME) network element 8-3 (the request could also include a modification request of any other parameter related to the connection or PDP context parameter). Such a request for a bearer resource modification 8-11 might request more resources (for example an increase of the guaranteed bandwidth). The MME validates the request and sends a Bearer Resource Command message 8-12 to the selected Serving Gateway (SGW) 8-4.

The SGW sends the Bearer Resource Command message 8-13 to a Packet Data Network Gateway (PDN-GW) 8-5. The PDN-GW contacts 8-14 the PCRF 8-6 and may retrieve (beside other information) policy rules and optionally measures related to the detection of frequent changes to a connection between a mobile device and a network.

In a next step the DARF function 8-7 (which might be integrated into the PDN-GW) performs a detection check according to the present invention in order to identify frequent changes to a network connection (here frequent PDF context modifications). If frequent changes to a connection between the mobile device 8-1 and the network are detected, the request for bearer resource modification issued by the mobile device might be for example rejected (not shown), or any other measure might be applied (refer to the detailed description of FIG. 4 where several examples of possible measures are given).

If no frequent changes to the connection are detected by the DARF function 8-7, and if all other requirements are fulfilled (like for example sufficient available resources to handle the request), the PDP context might be modified according to the request 8-15 and the session modification ends with step 8-16.

Similar diagrams could be drawn also for the PDP context activation and deactivation cases. If multiple mobile devices perform a coordinated PDP context modification/activation/deactivation this may be detected by the DARF function 8-7 by correlating the result from the checks performed for several mobile devices.

The signaling diagrams shown in FIGS. 6, 7 and 8 are just example diagrams shown 3 possible ways how the invention can be embodied into already existing procedures. Those signaling diagrams are not limiting the present invention to the shown networks or network elements.

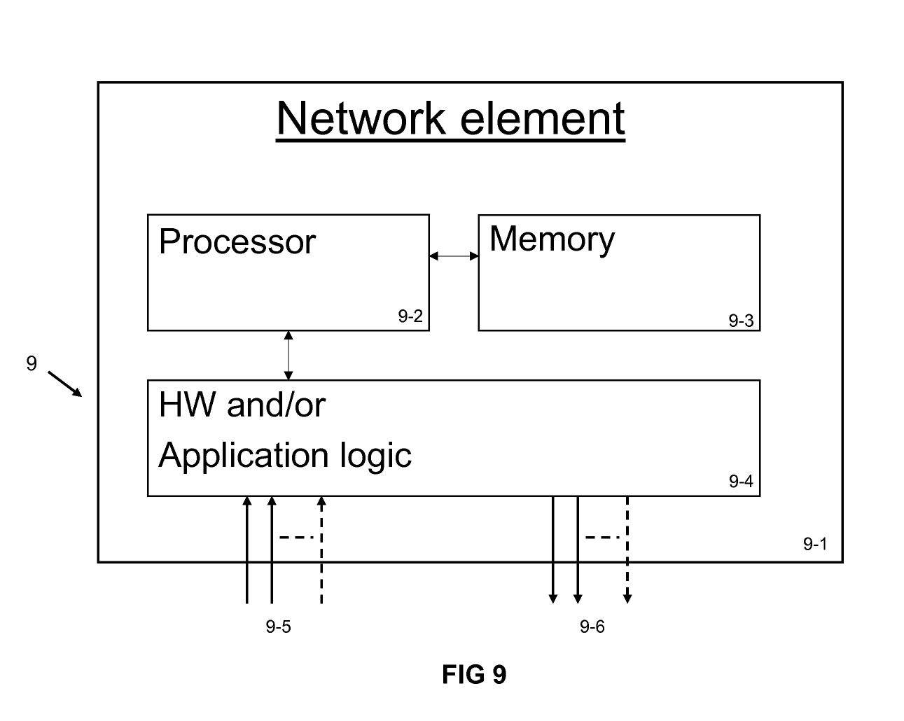

FIG. 9 shows a network element 9-1 implementing the present invention of detecting changes to a connection of at least one mobile device to a network. Compared to FIG. 5 this figures shows on a high level the software and hardware components where the invention (or at least parts of the invention) may be implemented. Such components may be a processor 9-2 (where a computer program which might implement parts of the invention may be running on), a memory 9-3 where the computer program may be stored in and where the process may fetch or deliver information/data from/to and other hardware and/or application logic (which might include for example the blocks shown in FIG. 5), where the application logic might interact with other network elements and/or mobile devices via at least one input 9-5 and at least one output 9-6. Alternatively the interaction with the external network elements/devices might happen also directly (not shown) via the processor 9-2.

Time aspects included in FIGS. 1 to 9 do not restrict any one of the shown steps to be limited to the step sequence as outlined. This applies in particular to method steps that may be functionally disjunctive with each other.

Without in any way limiting the scope, interpretation, or application of the claims appearing below, a technical effect of one or more of the example embodiments disclosed herein is to detect changes to a connection of at least one mobile device to a network and to apply measures to the at least mobile device, network elements or a network management system after detecting changes of the connection. This may be done in order to prevent for example possible DOS attacks causing frequent changes to the connection.

Embodiments of the present invention may be implemented in software, hardware, application logic or a combination of software, hardware and application logic. The software, application logic and/or hardware may reside on one or more network element, network devices or apparatuses. If desired, part of the software, application logic and/or hardware may reside on one or more core network element and part of the software, application logic and/or hardware may reside on one or more access network element. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 9 in connection with the network element shown in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

Reference signs included in the claims are added to show how the claims could be mapped to the example embodiments and are not limiting the scope of protection of the claims.

### USED ABBREVIATIONS

3GPP 3^{rd} Generation Partnership Project

AAA Authentication, Authorization, and Accounting

ANDSF Access Network Discovery and Selection Function

AP Access Point

ASN-GW Access Service Network Gateway

BSC Base Station Controller

BTS Base Transceiver Station

CDMA Code division multiple access

DARF DoS Attack Recognition Function

DoS Denial of Service

DDoS Distributed DOS

Digital Subscriber Line Access

DSLAM Multiplexer

EAP Extensible Authentication Protocol

EDGE Enhanced Data rates for GSM Evolution

EPS Evolved Packet System

E-UTRA Evolved Universal Terrestrial Radio Access

GERAN GSM EDGE Radio Access Network

GGSN Gateway GPRS Support Node

GPRS General Packet Radio Service

GSM Global System for Mobile communication

GTP Gateway Tunneling Protocol

GW Gateway

IMSI International Mobile Subscriber Identity

HO Handover

HSS Home Subscriber Server

IP Internet Protocol

IP-CAN IP Connectivity Access Network

LTE Long Term Evolution

MD Mobile Device

MME Mobility Management Entity

NE Network Element

NMS Network Management System

PCRF Policy and Charging Rule Function

vPCRF visited PCRF

hPCRF home PCRF

ePDG Evolved Packet Data Gateway

PDA Personal Digital Assistant

PDN-GW Packet Data Network Gateway

PDP Packet Data Protocol

PGW PDN Gateway (PDN-GW)

PMIP Proxy Mobile IP

QoS Quality of Service

RAN Radio Access Network

RNC Radio Network Controller

SAE System Architecture Evolution

SGSN Serving GPRS Support Node

SGW Serving Gateway

TEID Tunnel Endpoint Identifier

UMTS Universal Mobile Telecommunications System

UTRAN UMTS RAN

WIMAX Worldwide Interoperability for Microwave Access

WLAN Wireless Local Area Networks

1. A method for detecting changes to a connection of a mobile device to a network, whereby the detecting comprises determining if at least one-parameter related to the mobile device or related to the network is violating a policy rule related to the changes, and,
if it is determined that a policy rule is violated,. initiating at least one measure, wherein the changes to the connection are frequent handover actions.

2-5. (canceled)

6. The method of claim 1, wherein the at least one parameter related to the mobile device contains
number of completed handover actions of the mobile device, or
duration of the last connection of the mobile device to the network, or
number of connection changes to a network of the mobile device.

7. The method of claim 1, wherein the at least one parameter related to the network contains
number of completed handover actions in the network, or
number of completed handover actions in a part of the network, or
number of completed handover actions originated in at least one specific cell of the network, or
number of completed handover actions originated in the network, or
number of completed handover actions targeted to at least one specific cell of the network, or
number of completed handover actions targeted to the network.

8-11. (canceled)

12. The method of claim 1, wherein the policy rule is configurable and specific for the at least one parameter.

13. The method of claim 1, wherein different policy rules can be configured for different mobile devices, or different groups of mobile devices, or different groups of mobile users, or different parts of the network.

14. The method of claim 1, wherein the policy rule is violated if a threshold for the at least one parameter is passed within a defined period of time.

15-17. (canceled)

18. The method of claim 1, wherein the detecting comprises correlating at least one of the determination results and the selected parameters of at least two mobile devices.

19. The method of claim 1, wherein the at least one measure is one of
blocking access to the network of the mobile device, or
rejecting further attach or detach or handover requests of the mobile device, or
rejecting further Packet Data Protocol context activation, deactivation or modification requests of the mobile device, or
rejecting further changes requested to at least one parameter of the connection of the mobile device, or
constraining a list of available access networks to the mobile device, or
modifying at least one policy rule used to detect the changes to the connection of the mobile device, or
blocking network access for at least one application running on the mobile device.

20. The method of claim 19, wherein the at least one measure is only taken for a specific time.

21. The method of claim 1, wherein the at least one measure is one of
sending a message to the mobile device and inform a user about the detected frequent changes to the connection, or
sending a message to the mobile device asking for re-configuration of an access selection policy of the mobile device, or
informing a network management system.

22. An apparatus for detecting changes to a connection of a mobile device to a network, the apparatus comprising:
a determining block configured to determine if at least one parameter related to the mobile device or related to the network is violating a policy rule related to the changes, and
a measure block configured to initiate at least one measure if a policy rule is violated wherein the changes to the connection are frequent handover actions.

23-26. (canceled)

27. The apparatus of claim 22, wherein the at least one parameter related to the mobile device contains
number of completed handover actions of the mobile device, or
duration of the last connection of the mobile device to the network, or
number of connection changes to a network of the mobile device.

28. The apparatus of claim 22, wherein the at least one parameter related to the network contains
number of completed handover actions in the network, or
number of completed handover actions in a part of the network, or
number of completed handover actions originated in at least one specific cell of the network, or
number of completed handover actions originated in the network, or
number of completed handover actions targeted to at least one specific cell of the network, or
number of completed handover actions targeted to the network.

29-33. (canceled)

34. The apparatus of claim 22, wherein the policy rule is configurable and specific for the at least one parameter.

35. The apparatus of claim 22, wherein different policy rules can be configured for different mobile devices, different groups of mobile devices, different groups of mobile users, or different parts of the network.

36. The apparatus of claim 22, wherein the detecting block determines that the policy rule is violated if a threshold for the at least one parameter is passed within a defined period of time.

37. The apparatus of claim 22, further comprising correlating at least one of determination results and selected parameters of at least two mobile devices.

38. The apparatus of claim 22, wherein the at least one measure is one of
blocking access to the network of the mobile device, or
rejecting further attach or detach or handover requests of the mobile device, or
rejecting further Packet Data Protocol context activation, deactivation or modification requests of the mobile device, or
rejecting further changes requested to at least one parameter of the connection of the mobile device, or
constraining a list of available access networks to the mobile device, or
modifying at least one policy rule used to detect the changes to the connection of the mobile device, or
blocking network access for at least one application running on the mobile device.

39. The apparatus of claim 38, wherein the at least one measure is only taken for a specific time.

40. The apparatus of claim 22, wherein the at least one measure is one of
sending a message to the mobile device and inform a user about the detected changes to the connection, or
sending a message to the mobile device asking for re-configuration of an access selection policy of the mobile device, or
informing a network management system.

41. (canceled)

42. The apparatus of claim 22, wherein the changes to the connection are performed between at least two heterogeneous access networks.

43. The apparatus of claim 22, wherein the apparatus comprises one of a Policy and Charging Rules Function or a Packet Data Network Gateway or a Serving GPRS Support Node or a Mobility Management Entity or an evolved Packet Data Gateway.

44. A computer program embodied on a non-transitory computer-readable medium, comprising code for controlling a processor to perform the method according to claim 1.

45. (canceled)
